(19) United States
(12) Patent Application Publication
(10) Pub. No.: US 2025/0370905 A1
(43) Pub. Date: Dec. 4, 2025

(54) UNIFORM SOFTWARE ASSEMBLY PACKAGING

(71) Applicant: TOYOTA JIDOSHA KABUSHIKI KAISHA, Aichi-ken (JP)

(72) Inventor: Cyril COURTOY, Saint-Basile-le-Grand (CA)

(21) Appl. No.: 18/732,524

(22) Filed: Jun. 3, 2024

(51) Int. Cl. G06F 11/36

(52) U.S. Cl. CPC G06F 11/3608; G06F 11/3692

(57) ABSTRACT

Uniform software assembly packaging is performed by testing an equipment software assembly according to at least one testing script included in the equipment software assembly to obtain test result information, producing an equipment package from the equipment software assembly, wherein the produced equipment package is executable to install and validate software on a target hardware element of a vehicle architecture specification included in the equipment software assembly. The produced equipment package includes a plurality of binaries, each binary corresponding to a program package among a plurality of program packages included in the equipment software assembly and a building script included in the equipment software assembly, metadata including debugging information, a description of the produced equipment package, and the test result information.

### BACKGROUND

A vehicle system is composed of many Electronic Controller Units (ECUs), each ECU having a unique software stack. Integration of the many ECUs is performed using software code, software building tools, and software building methods.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a software assembly for uniform software assembly packaging, according to at least some embodiments of the subject disclosure.

FIG. 2 is an operational flow for uniform software assembly packaging, according to at least some embodiments of the subject disclosure.

FIG. 3 is an operational flow for package production, according to at least some embodiments of the subject disclosure.

FIG. 4 is a schematic diagram of a produced package for uniform software assembly packaging, according to at least some embodiments of the subject disclosure.

FIG. 5 is a block diagram of a hardware configuration for uniform software assembly packaging, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

As the level of complexity of the vehicle system increases, the building tools required to assemble the vehicle system becomes more specialized. However, the software building tools and the software building methods vary for software code among various ECUs of the vehicle system. Software code for a given ECU uses software building tools and software building methods that are beneficial to the given ECU without regard to other ECUs or the corresponding software code.

Software assemblies are uniformly packaged by testing an equipment software assembly according to at least one testing script included in the equipment software assembly to produce test result information, and producing an equipment package from the equipment software assembly. The produced equipment package is executable to install and validate software on a target hardware element of a vehicle architecture specification included in the equipment software assembly. The produced equipment package includes a plurality of binaries, each binary corresponding to a package included in the equipment software assembly among at least one operating system package, at least one middleware package, and at least one application package, and a building script included in the equipment software assembly, metadata including debugging information, a description of the produced equipment package, and the test result information.

Uniform packaging of software assemblies enables automation of building, packaging, testing, and deploying a software stack for each ECU and the vehicle system.

The inventors compare the software assembly in at least some embodiments to a high level mechanical assembly which combines a set of low level parts (single parts and/or other sub assemblies). Producing such a mechanical assembly requires a bit more information than a simple list of its low level parts in some cases. For example, an engine and a transmission of a powertrain system are connectable through two mechanical interfaces, a drive shaft for power distribution and a bolt pattern to align and fasten two sub assemblies.

Such a mechanical assembly not only requires a parts list, but also requires methods and tooling to integrate the parts into the higher level assembly. Tools themselves are also parts which are maintained in the Manufacturing Bill of Material (MBOM). At least some embodiments are similar in that software development tools are software parts, which are part of the Software Bill of Material (SBOM).

In at least some embodiments, a software part is a software component that fulfills a dedicated role in an integrated system. Like its hardware counterpart, software parts include assemblies of other software parts in at least some embodiments. In at least some embodiments, a software part refers to a collection of source code, the executable binaries into which the source code is compiled, the packages into which the source code is bundled.

In at least some embodiments, a software assembly is a specialized software part responsible for composing a system by integrating a set of other software parts. In at least some embodiments, a software part becomes a software assembly upon integration, in which multiple software units are assembled through either manual or scripting operations. In at least some embodiments, when a software assembly undergoes an automated integration operation, the software assembly combines its own software parts and software parts from its dependencies to form a bigger assembly.

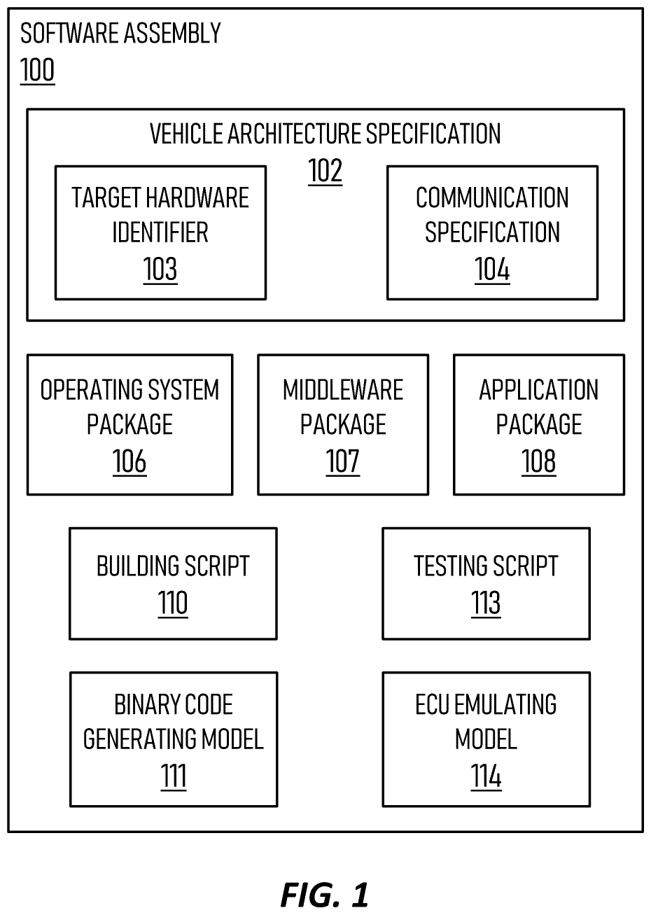

FIG. 1 is a schematic diagram of a software assembly for uniform software assembly packaging, according to at least some embodiments of the subject disclosure. Software assembly 100 includes vehicle architecture specification 102, target hardware element identifier 103, communication specification 104, operating system package 106, middleware package 107, application package 108, building script 110, binary code generating model 111, testing script 113, and ECU emulating model 114.

In at least some embodiments, software assembly 100 integrates the software parts. In at least some embodiments, software assembly 100 includes the software parts necessary for uniform software assembly packaging. In at least some embodiments, software assembly 100 is configured to integrate various components and manage their interactions to achieve the desired functionality. In at least some embodiments, software assembly 100 interacts with software parts, and coordinates functions of certain software parts to produce a uniform software assembly package. In at least some embodiments, software assembly 100 is a software project in a version control system, such as Git.

Vehicle architecture specification 102 includes target hardware element identifier 103 and communication specification 104. In at least some embodiments, vehicle architecture specification 102 defines the vehicle hardware and software architecture, which guides the software assembly process. In at least some embodiments, vehicle architecture specification 102 is configured to specify the requirements and constraints for the software to be installed on the vehicle's hardware elements. In at least some embodiments, vehicle architecture specification 102 interacts with software assembly 100 and target hardware element identifier 103 to ensure the software is compatible with the vehicle's hardware. In at least some embodiments, vehicle architecture specification 102 is a document or a digital file detailing the vehicle's hardware and software specifications. In at least some embodiments, vehicle architecture specification 102 is of a type used in the design and development of vehicle systems. In at least some embodiments, vehicle architecture specification 102 is used by an equipment software assembly as the reference architecture the equipment software assembly must implement. In at least some embodiments, the reference architecture dictates other dependencies as well as provide variation and configuration information. In at least some embodiments, the vehicle architecture specification includes an acceptable version of the at least one operating system package.

Target hardware element identifier 103 is part of vehicle architecture specification 102. In at least some embodiments, target hardware element identifier 103 interacts with software assembly 100 to guide the installation of the software on the correct hardware element. In at least some embodiments, target hardware element identifier 103 is configured to identify the specific hardware element in the vehicle where the software will be installed. In at least some embodiments, target hardware element identifier 103 is configured to accurately identify the target hardware element based on the vehicle architecture specification. In at least some embodiments, target hardware element identifier 103 is a unique identifier or a hardware address. In at least some embodiments, the target hardware element is an ECU of the vehicle architecture specification. In at least some embodiments, an equipment software assembly is responsible for implementing one of the ECU listed in the vehicle-architecture. In at least some embodiments, the part number of the equipment software assembly must match one of the equipment in the vehicle-architecture. In at least some embodiments, an equipment software assembly provides standard tools to extract the matching equipment definition file associated with the equipment software assembly. In at least some embodiments, if no match is found, then the equipment software assembly is invalid and must be fixed or deleted.

Communication specification 104 is part of vehicle architecture specification 102. In at least some embodiments, communication specification 104 interacts with the software assembly to enable the software to communicate effectively within the vehicle's system. In at least some embodiments, communication specification 104 is configured to define the communication protocols and standards to be used in the vehicle's system. In at least some embodiments, communication specification 104 is configured to specify the communication protocols for data exchange between different hardware elements in the vehicle. In at least some embodiments, communication specification 104 is a technical document detailing the communication protocols and standards. In at least some embodiments, communication specification 104 is of a type used in the design and development of communication systems in vehicles. In at least some embodiments, the vehicle architecture specification includes a CAN (Controller Area Network) communication specification. In at least some embodiments, the vehicle architecture specification includes a LAN (Local Area Network) communication specification.

Operating system package 106 is part of software assembly 100. In at least some embodiments, operating system package 106 interacts with the software assembly and the target hardware element identifier to install the operating system on the correct hardware element. In at least some embodiments, operating system package 106 is configured to provide the operating system necessary for the software to run on the vehicle's hardware. In at least some embodiments, operating system package 106 is configured to install and manage the operating system on the target hardware element. In at least some embodiments, operating system package 106 interacts with software assembly 100 and target hardware element identifier 103 to install the operating system on the correct hardware element. In at least some embodiments, operating system package 106 is a disk image or an installation package. In at least some embodiments, operating system package 106 is a LINUX operating system, such as DEBIAN. In at least some embodiments, as specified in vehicle architecture specification 102, every hardware target of an ECU requires a specific operating system, which is also a software part prescribed by an equipment definition in vehicle architecture specification 102. In at least some embodiments, an equipment software assembly must validate that the dependencies on the various operating system software parts are the ones prescribed by vehicle architecture specification 102, and then maintain the specific version to use. In at least some embodiments, vehicle architecture specification 102 might also prescribe an acceptable version range to prevent upgrading the operating system version without having permission. In at least some embodiments, every supported operating system is considered by the building or packaging process of a software part for equipment integration and considered as a “buildtime” variation point of the hardware target.

Middleware package 107 is part of software assembly 100. In at least some embodiments, middleware package 107 interacts with software assembly 100, operating system package 106, and application package 108 to ensure seamless interaction between different software components. In at least some embodiments, middleware package 107 is configured to provide the necessary middleware for the software to interact with the operating system and other software. In at least some embodiments, middleware package 107 is configured to install and manage the middleware on the target hardware element. In at least some embodiments, middleware package 107 is a library or a framework. In at least some embodiments, middleware package 107 is of a type used in software development and system integration. In at least some embodiments, vehicle architecture specification 102 prescribes the middleware software part to use. In at least some embodiments, similar to operating system package 106, if multiple middleware packages are used, the middleware packages are also considered as a “buildtime” variation point of the hardware target.

Application package 108 is part of software assembly 100. In at least some embodiments, application package 108 is configured to provide the application software to be installed on the vehicle system. In at least some embodiments, application package 108 is configured to install and manage the application software on the target hardware element. In at least some embodiments, application package 108 interacts with software assembly 100, operating system package 106, and middleware package 107 to ensure the application software runs correctly. In at least some embodiments, application package 108 is a source code file or an installation script. In at least some embodiments, vehicle architecture specification 102 prescribes applications that are allocated to the target hardware. In at least some embodiments, an equipment software assembly is then responsible for combining the applications with the middleware and operating system into a set of coherent and cohesive binaries to be packaged together.

Building script 110 is part of software assembly 100. In at least some embodiments, building script 110 is configured to automate the process of building the binaries from software assembly 100. In at least some embodiments, building script 110 is configured to compile and link the software components to produce the binaries. In at least some embodiments, building script 110 interacts with all the software components in software assembly 100 to build the binaries. In at least some embodiments, building script 110 is a Makefile or a script written in a scripting language like Python or Bash. In at least some embodiments, building script 110 is of the type used in software development and build automation.

Binary code generating model 111 is part of software assembly 100. In at least some embodiments, the equipment software assembly further includes a model 111 configured for generating binary code. In at least some embodiments, binary code generating model 111 is configured to generate the binary code from the software parts. In at least some embodiments, binary code generating model 111 is configured to translate the software parts, such as operating system package 106, middleware package 107, application package 108, and building script 110, into binary code that can be executed to install software on the target hardware element. In at least some embodiments, binary code generating model 111 is a compiler or a transpiler. In at least some embodiments, in addition to uniform software assembly packaging, binary code generating model 111 is used in software development and code generation. In at least some embodiments, logic for some classic ECUs is implemented using Simulink models. In at least some embodiments, vehicle architecture specification 102 prescribes the software part in which the Simulink model is implemented. In at least some embodiments, an equipment software assembly is configured to process the Simulink model to generate code of the application to be built and combined with the operating system and the middleware to generate official binaries of the target hardware.

Testing script 113 is part of software assembly 100. In at least some embodiments, testing script 113 is configured to automate the testing of the equipment software assembly. In at least some embodiments, testing script 113 is configured to execute test cases and produce test result information. In at least some embodiments, testing script 113 interacts with software assembly 100 and ECU emulating model 114 to test the software. In at least some embodiments, testing script 113 is a script written in a scripting language like Python or Bash, or a configuration file for a testing framework like JUnit or PyTest. In at least some embodiments, testing script 113 is of the type used in software testing and quality assurance. In at least some embodiments, the at least one testing script is configured to interact with a vehicle simulation. In at least some embodiments, testing script 113 is a system test software part that defines test cases and enables engineers to develop custom test steps implementations. In at least some embodiments, testing script 113 includes test steps which may depend on a system test library for interacting with test rigs. In at least some embodiments, testing script 113 includes custom test steps which analyze logs after execution of a test rig. In at least some embodiments, testing script 113 defines a test environment that refers to a specific test rig runtime configuration, such as an output package of a test rig configuration software part.

ECU emulating model 114 is part of software assembly 100. In at least some embodiments, the equipment software assembly further includes a model configured for emulating a neighboring ECU. In at least some embodiments, ECU emulating model 114 is configured to emulate a neighboring ECU for testing purposes. In at least some embodiments, ECU emulating model 114 is configured to mimic the behavior of a real ECU to provide a realistic testing environment. In at least some embodiments, ECU emulating model 114 interacts with testing script 113 to provide a realistic testing environment. In at least some embodiments, ECU emulating model 114 is a software model or a hardware-in-the-loop simulator. In at least some embodiments, ECU emulating model 114 is of the type used in hardware emulation and testing. In at least some embodiments, ECU emulating model 114 includes light weight models of the ECU that the equipment software assembly is targeting. In at least some embodiments, the light weight models may implement basic or complete logic for use in testing neighboring ECUs by simulating an environment in which the ECU is present and responding.

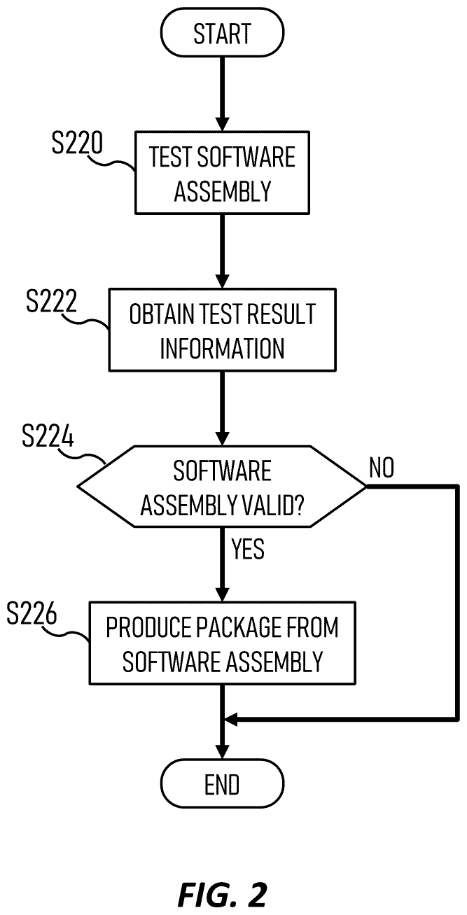

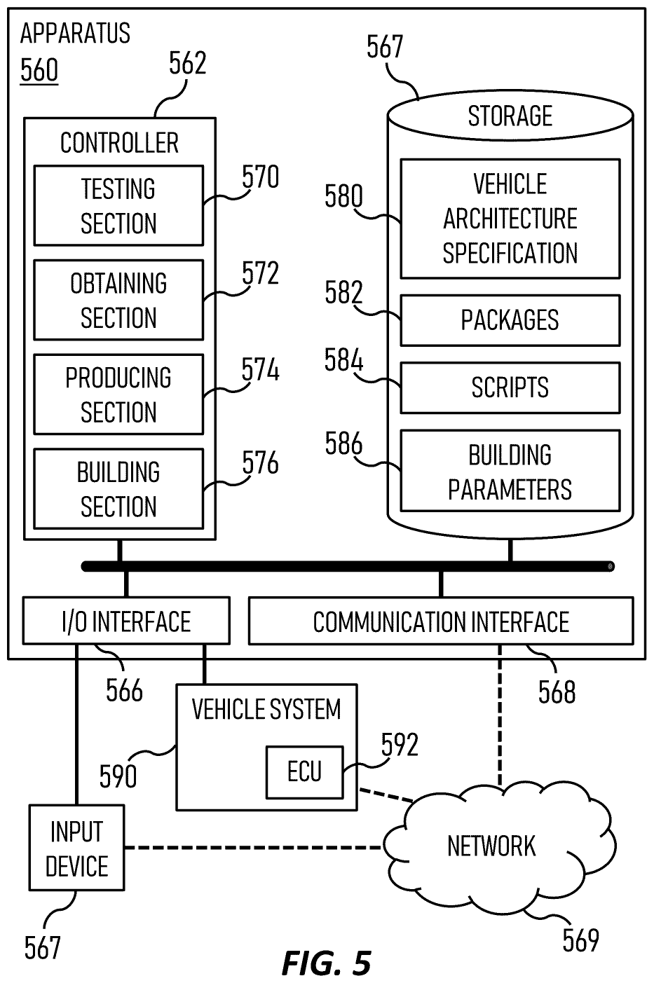

FIG. 2 is an operational flow for uniform software assembly packaging, according to at least some embodiments of the subject disclosure. In at least some embodiments, the operational flow provides a method of uniform software assembly packaging, according to at least some embodiments of the subject disclosure. In at least some embodiments, the method is performed by a controller of an apparatus, such as controller 562 of apparatus 560 of FIG. 5, described hereinafter.

At S220, the controller or a section thereof tests the software assembly. In at least some embodiments, the controller tests an equipment software assembly according to at least one testing script included in the equipment software assembly to obtain test result information. In at least some embodiments, the controller tests a vehicle software assembly according to at least one vehicle testing script included in the vehicle software assembly to produce vehicle test result information. In at least some embodiments, the controller executes at least one testing script included in the equipment software assembly. In at least some embodiments, the controller performs this operation when the software assembly and the testing script are available. In at least some embodiments, the controller generates test result information as a result of this operation. In at least some embodiments, the controller validates every equipment automatically by running a series of system tests organized through test plans of a testing script, such as testing script 113. In at least some embodiments, the controller validates every vehicle configuration automatically by running a series of system tests organized through test plans of a testing script, such as testing script 113.

At S222, the controller or a section thereof obtains the test result information. In at least some embodiments, the controller collects the output from the testing script execution. In at least some embodiments, the controller collects the output from the testing script execution in response to the successful completion of the software assembly testing. In at least some embodiments, the controller provides insights into the software assembly's performance and functionality through the test result information. In at least some embodiments, the test result information provides the data to determine whether the software assembly is valid and ready for packaging.

At S224, the controller or a section thereof determines whether the software assembly is valid. In response to the software assembly not being valid, the operational flow ends. In response to the software assembly being valid, the operational flow proceeds to produce a package from the software assembly at S226. In at least some embodiments, the controller evaluates the test result information to determine if the software assembly is valid during operation S224. In at least some embodiments, the controller evaluates the test result information in response to the test result information becoming available. In at least some embodiments, the controller ensures that only valid and functional software assemblies are packaged.

At S226, the controller or a section thereof produces a package from the software assembly. In at least some embodiments, the controller produces an equipment package from the equipment software assembly, wherein the produced equipment package is executable to install and validate software on a target hardware element of a vehicle architecture specification included in the equipment software assembly. In at least some embodiments, the controller produces a vehicle package from the vehicle software assembly, wherein the vehicle package is executable to install and validate software on each hardware element, including the target element, of the vehicle architecture specification. In at least some embodiments, the controller produces an equipment package from the validated software assembly. In at least some embodiments, the controller produces an executable package that can install and validate software on a target hardware element. In at least some embodiments, the controller produces the equipment package in response to validation of the software assembly. In at least some embodiments, the producing includes building the plurality of binaries. In at least some embodiments, the controller includes binaries, a building script, metadata, a description, and the test result information in the produced equipment package. In at least some embodiments, the controller packages the validated software assembly into a deployable and executable format.

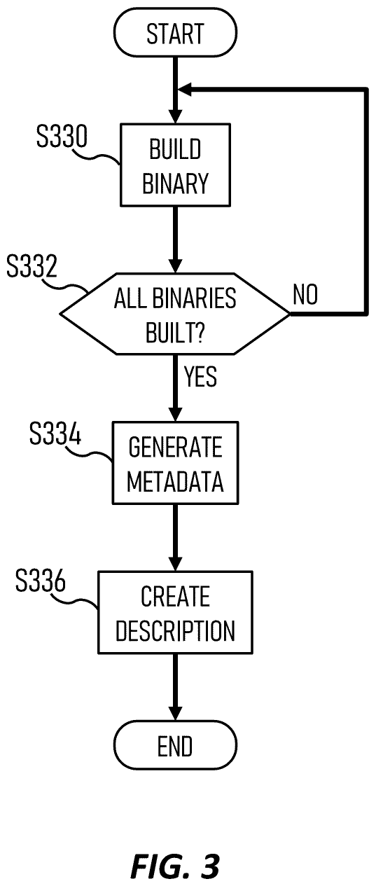

FIG. 3 is an operational flow for package production, according to at least some embodiments of the subject disclosure. In at least some embodiments, the operational flow provides a method of package production, according to at least some embodiments of the subject disclosure. In at least some embodiments, the method is performed by a controller of an apparatus, such as controller 562 of apparatus 560 of FIG. 5, described hereinafter.

At S330, the controller or a section thereof builds binary files from the source code. In at least some embodiments, the controller constructs binary files from the source code present in the equipment software assembly. In at least some embodiments, the controller builds binary files ready for inclusion in the final equipment package. In at least some embodiments, the controller transforms the human-readable source code into machine-executable binary files. In at least some embodiments, an equipment binaries package combines all the binaries that need to be installed on the target hardware. In at least some embodiments, the equipment binaries package references other packages, re-packages other packages, or a combination of both. In at least some embodiments, the equipment retarget binaries is a specialization of the equipment binaries. In at least some embodiments, the equipment retarget binaries are for Software In the Loop Simulation (SILS) tests. In at least some embodiments, a functional way to integrate SILS with equipment retarget binaries is using Docker containers. In at least some embodiments, the equipment retarget binaries are re-packaged and at least partially pre-configured within a Docker image. In at least some embodiments, Docker images provide similar metadata about configuration, execution and communication interfaces. In at least some embodiments, the equipment retarget binaries requires middleware configured to integrate with the retarget equipment. In at least some embodiments, the equipment retarget binaries package provides metadata interpretable by the retarget equipment, such as information about a configuration interface, about configuring execution and communication interfaces of the equipment binaries (i.e. define IP addresses, ports, parameters, option selection, etc.). In at least some embodiments, the metadata includes information about an execution interface, such as how to execute the binaries (i.e. start/stop scripts, executable, etc.), about a communication interface, such as a list of the communication channels and their types. In at least some embodiments, the metadata enables the target hardware to receive input from and transmit output to the network of the vehicle system (i.e. CAN Buses, Ethernet, Discretes, Analogs, etc.).

At S332, the controller or a section thereof determines whether all binaries have been built. In response to all binaries not being built, the operational flow returns to building binary files at S330. In response to all binaries being built, the operational flow proceeds to generating metadata at S334. In at least some embodiments, the controller ensures that all necessary components are ready before proceeding to the next steps of the packaging process.

At S334, the controller or a section thereof generates metadata. In at least some embodiments, the controller generates metadata that includes debugging information. In at least some embodiments, the controller generates metadata in response to the successful building and verification of all binaries. In at least some embodiments, the controller generates metadata in a metadata file. In at least some embodiments, the metadata file provides valuable information about the binaries and the build process.

At S336, the controller or a section thereof creates a description of the produced equipment package. In at least some embodiments, the controller creates a description of the produced equipment package in response to the successful generation of metadata. In at least some embodiments, the controller creates a comprehensive description of the equipment package. In at least some embodiments, the controller creates a description that can be used for documentation and understanding the package's contents. In at least some embodiments, the controller creates a description that provides a human-readable overview of the package.

In at least some embodiments, a vehicle software assembly does not generate any packages containing binaries. In at least some embodiments, the vehicle software assembly packages test results and documentation.

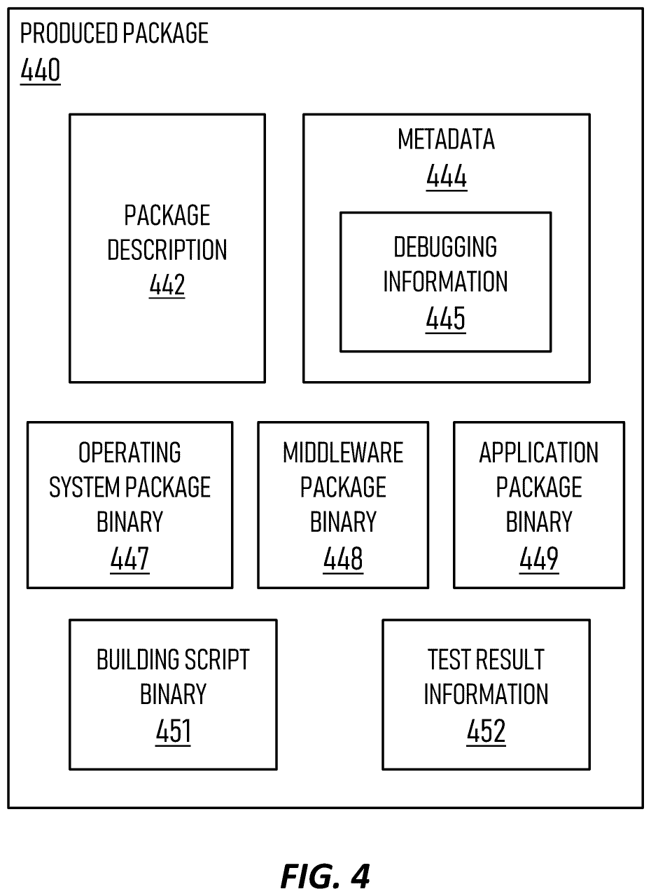

FIG. 4 is a schematic diagram of a produced package 440 for uniform software assembly packaging, according to at least some embodiments of the subject disclosure. Produced package 440 includes package description 442, metadata 444, debugging information 445, operating system package binary 447, middleware package binary 448, application package binary 449, building script binary 451, and test result information 452. In at least some embodiments, the produced equipment package includes a plurality of binaries, each binary corresponding to a program package among a plurality of program packages included in the equipment software assembly and a building script included in the equipment software assembly. In at least some embodiments, the program packages include at least one operating system package, at least one middleware package, and at least one application package.

In at least some embodiments, produced package 440 is output of a uniform software assembly packaging process. In at least some embodiments, produced package 440 contains components to install and validate software on a target hardware element. In at least some embodiments, produced package 440 is executable. In at least some embodiments, produced package 440 is configured to install software. In at least some embodiments, produced package 440 interacts with the target hardware element during the installation process. In at least some embodiments, produced package 440 is a .exe file in Windows or a .deb file in Linux.

Package description 442 is part of produced package 440. In at least some embodiments, the produced equipment package includes a description of the produced equipment package. In at least some embodiments, package description 442 provides a summary of the contents and functionality of produced package 440. In at least some embodiments, package description 442 is configured to clearly communicate the purpose and contents of the package to users or other software. In at least some embodiments, package description 442 is a README file or an embedded description within the package metadata. In at least some embodiments, package description 442 is a documentation package configured for integration in a documentation system of a domain.

Metadata 444 includes debugging information 445 and is part of produced package 440. In at least some embodiments, metadata 444 stores additional information about produced package 440. In at least some embodiments, metadata 444 includes a version number, dependencies, author identification, etc. In at least some embodiments, metadata 444 is configured to store a variety of data types and structures. In at least some embodiments, metadata 444 is configured to be read by package managers and other software to understand the package's requirements and properties. In at least some embodiments, metadata 444 is a JSON or XML file. In at least some embodiments, metadata 444 is embedded within the package file.

Debugging information 445 is part of metadata 444. In at least some embodiments, a produced equipment package includes metadata including debugging information. In at least some embodiments, debugging information 445 is configured to help developers identify and fix issues in the software contained in produced package 440. In at least some embodiments, debugging information 445 is configured to provide detailed error messages, stack traces, and other information useful for debugging. In at least some embodiments, debugging information 445 is configured for use by debugging tools to help developers understand and fix issues. In at least some embodiments, debugging information 445 is a log file or embedded within the package file. In at least some embodiments, debugging information 445 is of the type used in software development to help identify and fix issues. In at least some embodiments, debugging information 445 includes debug symbols to be resolved when using a debugger, such as GNU Project Debugger (GDB) to attach to equipment processes. In at least some embodiments, debugging information 445 includes definitions of internal debug Application Programming Interfaces (APIs), which can be used by a testing framework, such as Cockpit Software Development Kit (SDK) API, Flutter Testing Framework server, etc., to perform assertions or white box testing ability as part of a system testing strategy. In at least some embodiments, debugging information 445 includes Docker Image configuration, execution and communication interfaces information. In at least some embodiments, debugging information 445 has very limited access rights to prevent exposure of private information. In at least some embodiments, a user of the target hardware should not have access to debugging information 445. In at least some embodiments, debugging information 445 is kept when deployed to production so that in-production issues can be debugged by testing framework and developers responsible for the target hardware.

Operating system package binary 447 is part of produced package 440. In at least some embodiments, operating system package binary 447 contains the compiled code for the operating system package included in the equipment software assembly. In at least some embodiments, operating system package binary 447 is configured for execution by the target hardware element to install the operating system. In at least some embodiments, operating system package binary 447 interacts with the target hardware element during the installation process. In at least some embodiments, operating system package binary 447 is a .bin file or other executable file format. In at least some embodiments, operating system package binary 447 is of the type used in operating system installation media.

Middleware package binary 448 is part of produced package 440. In at least some embodiments, middleware package binary 448 contains the compiled code for the middleware package included in the equipment software assembly. In at least some embodiments, middleware package binary 448 is executed by the operating system to install the middleware. In at least some embodiments, middleware package binary 448 interacts with the operating system during the installation process. In at least some embodiments, middleware package binary 448 is a .bin file or other executable file format. In at least some embodiments, middleware package binary 448 is of the type used in software installation packages.

Application package binary 449 is part of produced package 440. In at least some embodiments, application package binary 449 contains the compiled code for the application package included in the equipment software assembly. In at least some embodiments, application package binary 449 is executed by the operating system to install the application. In at least some embodiments, application package binary 449 interacts with the operating system during the installation process. In at least some embodiments, application package binary 449 is a .bin file or other executable file format. In at least some embodiments, application package binary 449 is of the type used in software installation packages.

Building script binary 451 is part of produced package 440. In at least some embodiments, building script binary 451 automates the process of compiling and building certain software parts from source code. In at least some embodiments, building script binary 451 is configured to execute a series of commands to compile and build certain software parts. In at least some embodiments, building script binary 451 is a shell script or a .bin file or other executable file format.

Test result information 452 is part of produced package 440. In at least some embodiments, the produced equipment package includes the test result information. In at least some embodiments, test result information 452 provides the results of testing the software assembly. In at least some embodiments, test result information 452 includes data representing pass/fail information, error messages, and other test results. In at least some embodiments, test result information 452 is obtained from a software assembly testing operation, such as operation S220 of FIG. 2. In at least some embodiments, test result information 452 is configured for developers or other software to understand the quality of the software assembly of produced package 440. In at least some embodiments, test result information 452 is a text file, a JSON file, embedded within the package file, etc. In at least some embodiments, test results are used in software development to ensure the quality of the software. In at least some embodiments, test result information 452 is identical to test result information published to a software production line or to a datastore with logs and other generated test artifacts, such as screen recordings, sound recordings, core dumps, etc.

FIG. 5 is a block diagram of a hardware configuration for uniform software assembly packaging, according to at least some embodiments of the subject disclosure.

The exemplary hardware configuration includes apparatus 560, which interacts with input device 567, vehicle system 590, and ECU 592, directly or through network 569. In at least some embodiments, input device 567 is a touch screen, a microphone, a camera, or any other device configured to detect tactile, aural, visual, etc. input. In at least some embodiments, vehicle system 590 is a computing system of a vehicle. In at least some embodiments, vehicle system 590 includes controllers, such as ECU 592, in communication through a network, such as a Controller Area Network (CAN). In at least some embodiments, network 569 is an ethernet network or any other wired or wireless network or a combination thereof. In at least some embodiments, apparatus 560 is a computer or other computing device that receives input or commands from input device 567. In at least some embodiments, apparatus 560 is integrated with input device 567. In at least some embodiments, apparatus 560 is a computer system that executes computer-readable instructions to perform operations for uniform software assembly packaging.

Apparatus 560 includes a controller 562, a storage 564, an input/output interface 566, and a communication interface 568. In at least some embodiments, controller 562 includes a processor or programmable circuitry executing instructions to cause the processor or programmable circuitry to perform operations according to the instructions. In at least some embodiments, controller 562 includes analog or digital programmable circuitry, or any combination thereof. In at least some embodiments, controller 562 includes physically separated storage or circuitry that interacts through communication. In at least some embodiments, storage 564 includes a non-volatile computer-readable medium capable of storing executable and non-executable data for access by controller 562 during execution of the instructions. In at least some embodiments, communication interface 568 transmits and receives data from network 569. In at least some embodiments, input/output interface 566 connects to various input and output units, such as input device 567, via a parallel port, a serial port, a keyboard port, a mouse port, a monitor port, and the like to accept commands and present information. In some embodiments, storage 564 is external from apparatus 560.

Controller 562 includes testing section 570, obtaining section 572, producing section 574, and building section 576. Storage 564 includes vehicle architecture specification 580, packages 582, scripts 584, and building parameters 586.

Testing section 570 is the circuitry or instructions of controller 562 configured to test software assemblies. In at least some embodiments, testing section 570 is configured to test an equipment software assembly according to at least one testing script included in the equipment software assembly. In at least some embodiments, testing section 570 utilizes information in storage 564, such as vehicle architecture specification 580, packages 582, and scripts 584. In at least some embodiments, testing section 570 includes sub-sections for performing additional functions, as described in the foregoing flow charts. In at least some embodiments, such sub-sections are referred to by a name associated with a corresponding function.

Obtaining section 572 is the circuitry or instructions of controller 562 configured to obtain test result information. In at least some embodiments, obtaining section 572 is configured to obtain the test result information in response to testing the equipment software assembly according to the at least one testing script included in the equipment. In at least some embodiments, obtaining section 572 records information in storage 564, such as packages 582. In at least some embodiments, obtaining section 572 includes sub-sections for performing additional functions, as described in the foregoing flow charts. In at least some embodiments, such sub-sections are referred to by a name associated with a corresponding function.

Producing section 574 is the circuitry or instructions of controller 562 configured to produce packages from software assemblies. In at least some embodiments, producing section 574 is configured to producing an equipment package from the equipment software assembly, wherein the produced equipment package is executable to install and validate software on a target hardware element of a vehicle architecture specification included in the equipment software assembly. In at least some embodiments, producing section 574 utilizes information in storage 564, such as vehicle architecture specification 580, packages 582, scripts 584, and building parameters 586. In at least some embodiments, producing section 574 includes sub-sections for performing additional functions, as described in the foregoing flow charts. In at least some embodiments, such sub-sections are referred to by a name associated with a corresponding function.

Building section 576 is the circuitry or instructions of controller 562 configured to build binaries. In at least some embodiments, building section 576 is configured to build a plurality of binaries. In at least some embodiments, building section 576 utilizes information in storage 564, such as packages 582 and scripts 584. In at least some embodiments, building section 576 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, uniform software assembly packaging is performed by testing an equipment software assembly according to at least one testing script included in the equipment software assembly to obtain test result information, producing an equipment package from the equipment software assembly, wherein the produced equipment package is executable to install and validate software on a target hardware element of a vehicle architecture specification included in the equipment software assembly, the produced equipment package including; a plurality of binaries, each binary corresponding to a program package among a plurality of program packages included in the equipment software assembly and a building script included in the equipment software assembly, metadata including debugging information, a description of the produced equipment package, and the test result information. In at least some embodiments, the at least one testing script is configured to interact with a vehicle simulation. In at least some embodiments, the target hardware element is an ECU of the vehicle architecture specification. In at least some embodiments, the equipment software assembly further includes a model configured for emulating a neighboring ECU. In at least some embodiments, the producing includes building the plurality of binaries. In at least some embodiments, the equipment software assembly further includes a model configured for generating binary code. In at least some embodiments, uniform software assembly packaging further includes testing a vehicle software assembly according to at least one vehicle testing script included in the vehicle software assembly to produce vehicle test result information. In at least some embodiments, uniform software assembly packaging further includes producing a vehicle package from the vehicle software assembly, wherein the vehicle package is executable to install and validate software on each hardware element, including the target element, of the vehicle architecture specification. In at least some embodiments, the program packages include at least one operating system package, at least one middleware package, and at least one application package. In at least some embodiments, the vehicle architecture specification includes a CAN (Controller Area Network) communication specification. In at least some embodiments, the vehicle architecture specification includes a LAN (Local Area Network) communication specification. In at least some embodiments, the vehicle architecture specification includes an acceptable version of the at least one operating system package.

In at least some embodiments, uniform software assembly packaging is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium having instructions recorded thereon that, in response to execution by one or more processors, cause performance of operations comprising:
testing an equipment software assembly according to at least one testing script included in the equipment software assembly to obtain test result information;
producing an equipment package from the equipment software assembly, wherein the produced equipment package is executable to install and validate software on a target hardware element of a vehicle architecture specification included in the equipment software assembly, the produced equipment package including:
a plurality of binaries, each binary corresponding to a program package among a plurality of program packages included in the equipment software assembly and a building script included in the equipment software assembly,
metadata including debugging information,
a description of the produced equipment package, and
the test result information.

2. The computer-readable medium of claim 1, wherein the at least one testing script is configured to interact with a vehicle simulation.

3. The computer-readable medium of claim 1, wherein the target hardware element is an ECU of the vehicle architecture specification.

4. The computer-readable medium of claim 3, wherein the equipment software assembly further includes a model configured for emulating a neighboring ECU.

5. The computer-readable medium of claim 1, wherein the producing includes building the plurality of binaries.

6. The computer-readable medium of claim 5, wherein the equipment software assembly further includes a model configured for generating binary code.

7. The computer-readable medium of claim 1, wherein the operations further comprise testing a vehicle software assembly according to at least one vehicle testing script included in the vehicle software assembly to produce vehicle test result information.

8. The computer-readable medium of claim 7, wherein the operations further comprise producing a vehicle package from the vehicle software assembly, wherein the vehicle package is executable to install and validate software on each hardware element, including the target element, of the vehicle architecture specification.

9. The computer-readable medium of claim 1, wherein the program packages include at least one operating system package, at least one middleware package, and at least one application package.

10. The computer-readable medium of claim 1, wherein the vehicle architecture specification includes a CAN (Controller Area Network) communication specification.

11. The computer-readable medium of claim 1, wherein the vehicle architecture specification includes a LAN (Local Area Network) communication specification.

12. The computer-readable medium of claim 1, wherein the vehicle architecture specification includes an acceptable version of the at least one operating system package.

13. A method comprising:
testing an equipment software assembly according to at least one testing script included in the equipment software assembly to obtain test result information;
producing an equipment package from the equipment software assembly, wherein the produced equipment package is executable to install and validate software on a target hardware element of a vehicle architecture specification included in the equipment software assembly, the produced equipment package including:
a plurality of binaries, each binary corresponding to a program package among a plurality of program packages included in the equipment software assembly and a building script included in the equipment software assembly,
metadata including debugging information,
a description of the produced equipment package, and
the test result information.

14. The method of claim 13, wherein the at least one testing script is configured to interact with a vehicle simulation.

15. The method of claim 13, wherein the target hardware element is an ECU of the vehicle architecture specification.

16. The method of claim 15, wherein the equipment software assembly further includes a model configured for emulating a neighboring ECU.

17. The method of claim 13, wherein the producing includes building the plurality of binaries.

18. The method of claim 17, wherein the equipment software assembly further includes a model configured for generating binary code.

19. The method of claim 13, further comprising further comprising testing a vehicle software assembly according to at least one vehicle testing script included in the vehicle software assembly to produce vehicle test result information.

20. A device comprising:
a controller including circuitry configured to perform operations including testing an equipment software assembly according to at least one testing script included in the equipment software assembly to obtain test result information,
producing an equipment package from the equipment software assembly, wherein the produced equipment package is executable to install and validate software on a target hardware element of a vehicle architecture specification included in the equipment software assembly, the produced equipment package including:
a plurality of binaries, each binary corresponding to a program package among a plurality of program packages included in the equipment software assembly and a building script included in the equipment software assembly,
metadata including debugging information,
a description of the produced equipment package, and
the test result information.
